(19) United States
(12) Patent Application Publication
(10) Pub. No.: US 2010/0017023 A1
(43) Pub. Date: Jan. 21, 2010

(54) Automated dispensing device

(75) Inventors: Robert A. Jacomet, Largo, FL (US); Thedfred E. Franks, Highland Village, TX (US); Charles J. Fink, Haymarket, VA (US)

Correspondence Address: Giesecke & Devrient America,Inc., 45925 Horseshoe Drive, Dulles, VA, 20166, US

(73) Assignee: Giesecke & Devrient America,Inc., Dulles, VA (US)

(21) Appl. No.: 12/458,693

(22) Filed: Jul. 20, 2009

Related U.S. Application Data
(60) Provisional application No. 61/129,794, filed on Jul. 18, 2008.

(51) Int. Cl. G06F 17/00; B65D 83/00

(52) U.S. Cl. 700/236; 221/1

(57) ABSTRACT

An automated dispensing device is disclosed for dispensing items of value. Included is the dispensing device and inventory/control software.

This application claims the benefit of U.S. Provisional Application No. 61/129,794, filed Jul. 18, 2008, which is hereby incorporated by reference in its entirety.

### BACKGROUND

1. Field of the Invention

The present invention relates generally to dispensing items. More particularly, the present invention relates to dispensing items from an automated dispensing device.

2. Description of the Related Art

Traditional vending machines enable consumers to select and pay for a variety of items that can conveniently be retrieved. These machines typically include an interface that enables a user to select an item to be dispensed and a mechanism, such as a carousel, for delivering the item to a compartment or bin that is accessible to the consumer. Vending machine inventory is maintained by a technician dispatched to collect deposited cash and manually determine which items must be replaced. The vending machine concept has been adapted for dispensing beyond food products, such as tools, parts, and supplies. A problem with traditional vending machines, however, is that they lack the functionality and control to accommodate high-value goods with adequate security. Accordingly, what is needed is a vending machine that can securely accommodate high-value goods.

### SUMMARY

The present invention has been developed to address the above and other problems in the related art. According to exemplary embodiments of the present invention, a system of dispensing items is disclosed. The system includes a dispensing device including a plurality of compartments for holding said items of value, a plurality of doors through which items of value are placed into or removed from a compartment. The system further includes a moving mechanism for moving said compartments to positions adjacent the doors, and local control software for controlling said moving mechanism and for opening said doors to provide access to respective compartments positioned adjacent said doors. The system further includes a workstation connected to the dispensing device, the workstation including central inventory and control software for tracking contents of said compartments and for providing instructions to cause said local control software to open said doors.

According to exemplary embodiments of the present invention, a method of dispensing items is disclosed. The method includes providing a dispensing device including a plurality of compartments for holding said items of value, a plurality of doors through which items of value are placed into or removed from a compartment, a moving mechanism for moving said compartments to positions adjacent the doors, and local control software for controlling said moving mechanism and for opening said doors to provide access to respective compartments positioned adjacent said doors. The method further includes using a workstation connected to the dispensing device to track contents of said compartments and for providing instructions to cause said local control software to open said doors.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The above and/or other exemplary features and advantages of the preferred embodiments of the present invention will become more apparent through the detailed description of exemplary embodiments thereof with reference to the accompanying drawings, in which:

FIG. 1 is a perspective view of a dispensing device in accordance with an exemplary embodiment of the present invention.

FIG. 2 is a plan view of the dispensing device of FIG. 1.

FIG. 3 is a schematic diagram of a “stand-alone” dispensing system in accordance with an exemplary embodiment of the present invention.

FIG. 4 is a schematic diagram of a multiple device dispensing system in accordance with an exemplary embodiment of the present invention.

FIG. 5 is a flowchart of a pre-assembly software routine for the dispensing system in accordance with an exemplary embodiment of the present invention.

FIG. 6 is a flowchart of a device loading software routine for the dispensing system in accordance with an exemplary embodiment of the present invention.

FIG. 7 is a flowchart of a dispense error software routine for the dispensing system in accordance with an exemplary embodiment of the present invention.

FIG. 8 is a flowchart of a item dispensing software routine for the dispensing system in accordance with an exemplary embodiment of the present invention;

FIG. 9A is a flowchart of a pre-assemble process in accordance with an exemplary embodiment of the present invention;

FIG. 9B is a flowchart of a DB schema pre-assemble process in accordance with an exemplary embodiment of the present invention;

FIG. 10 is a flowchart of a BankOut profile in accordance with an exemplary embodiment of the present invention;

FIG. 11 is a flowchart of an employee profile in accordance with an exemplary embodiment of the present invention;

FIG. 12 is a flowchart of an audit function in accordance with an exemplary embodiment of the present invention; and

FIG. 13 is a flowchart of a DB Machine Schema in accordance with an exemplary embodiment of the present invention.

Throughout the drawings, like reference numbers and labels should be understood to refer to like elements, features, and structures.

### DETAILED DESCRIPTION

Exemplary embodiments of the present invention will now be described more fully with reference to the accompanying drawings. The matters exemplified in this description are provided to assist in a comprehensive understanding of various embodiments of the present invention disclosed with reference to the accompanying figures. Accordingly, those of ordinary skill in the art will recognize that various changes and modifications of the embodiments described herein can be made without departing from the scope and spirit of the claimed invention. Descriptions of well-known functions and constructions are omitted for clarity and conciseness. To aid in clarity of description, the terms “upper,” “lower,” “above,” “below,” “left” and “right,” as used herein, provide reference with respect to orientation of the accompanying drawings and are not intended to be limiting.

To facilitate description of certain embodiments of the present invention, definitions of a number of terms will be provided. It should be understood, however, that while definitions aid in understanding embodiments of the present invention, they are merely illustrations of meaning and are not intended to limit the absolute scope or application of a particular term. Rather, the definitions presented herein serve as exemplary descriptions and contemplate additional uses and applications of the terms.

Bank: A collection of items. The items include such media as cash, cash equivalents, minerals, gems, jewelry, and any other non-cash items.

Template: A construct that defines the amount, quantity, configuration, collection or arrangement of items that comprise the Bank.

Machine Template: A Template that is applied to one or more dispensing devices.

Bank Template: A Template that is applied to one or more Banks.

Bag: a container that holds the items which comprise the Bank.

BankID: an identifier assigned to a Bank, such as, for example, a serial number.

BinID: a logical address/identifier for each slot of the dispensing device.

BES: a dispensing device in accordance with an exemplary embodiment of the present invention.

Exemplary embodiments of the present invention provide an automated dispensing device, system, and method for distribution of items in a manner employing enhanced security features that might be found in, for example, a casino environment where, as part of normal daily operations, employees transport items of high value, such as cash worth thousands of dollars. For example, the system can be useful in a casino back office environment for distributing cash to floor workers, but may also be used in other environments or venues for dispensing high value items other than cash. Examples of environments that might require enhanced, flexible security and tighter inventory control include, though not exclusive, hospital supply dispensaries, establishments handling the sale or distribution of valuable inventory, and armories for law enforcement or military personnel. Included within embodiments of the present invention is central inventory and control software that provides tracking and logging of all transactions, inventory maintenance functions, and required systems services such as notifications when additional items are needed to keep quantities above threshold settings for each type of item. Exemplary features of embodiments of the present invention include separate access and inventory control functions, which are removed to a separate computing device to provide user authentication and profile management, inventory and transaction tracking and management, and reporting functions.

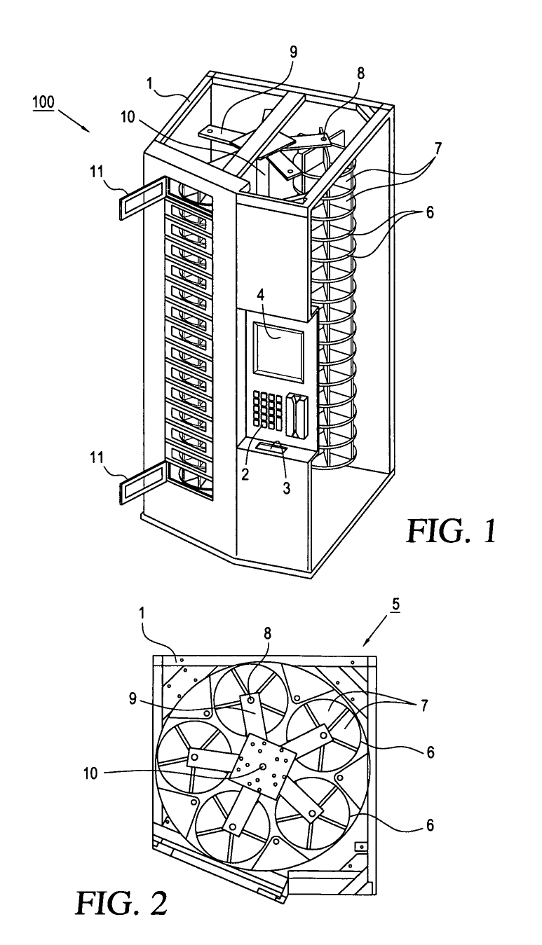

FIGS. 1 and 2 illustrate perspective and plan views, respectively, of a dispensing device 100 in accordance with an exemplary embodiment of the present invention. FIG. 1 includes a housing 1 with an external user interface consisting of a keypad 2, reader 3, display 4, and internal item storage and dispensing mechanism 5 (FIG. 2). Internal item storage and dispensing mechanism 5 includes a plurality of trays 6, each having multiple compartments 7 and arranged to rotate about a vertical axle 8, which in turn is mounted on arms 9 connected to a central axle 10 such that an entire stack of trays can be moved adjacent the dispensing doors 11 by rotation about the central axle 10, followed by rotation about vertical axle 8 to bring individual compartments 6 into alignment with the doors 11 so that the compartments 7 can be filled or emptied. In an exemplary embodiment, the doors 11 of the automated dispensing device are opened by a solenoid and spring mechanism controlled by a local processor in the housing 1, and arranged to be manually closed once an item has been inserted or removed.

Reader 3 can be any input device as would be known to those of ordinary skill in the art. By way of example and not limitation, reader 3 can comprise a barcode scanner, an electronic signature or biometric input pad/device, a magnetic, optical, or integrated circuit card input device or reader, a proximity reader, or RFID reader. Any combinations of the input devices can be provided for as well, such as, for example, RFID reader, magnetic stripe reader, and barcode reader. Exemplary embodiments provide a Webcam device (not shown) for video monitoring of dispenser 100.

In the exemplary embodiment of FIG. 1, 15 automated doors and 5 vertical tray assemblies are shown, though the number and configuration of doors and tray assemblies may vary. The trays 6 are designed to have varying number of compartments 7, depending on the size of the items to be dispensed. In an exemplary embodiment, access is provided to as many as 1050 items if each of the trays are divided into 14 compartments.

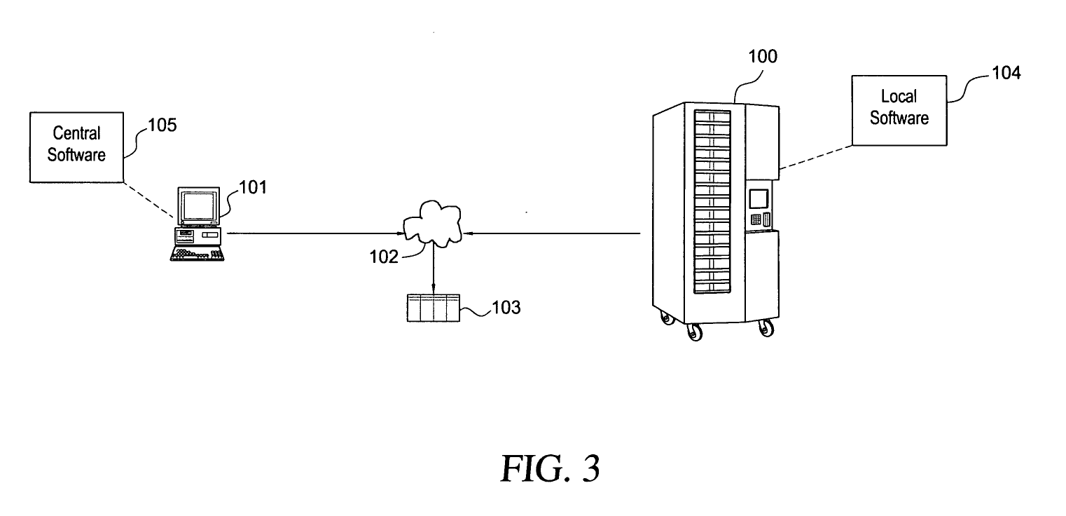

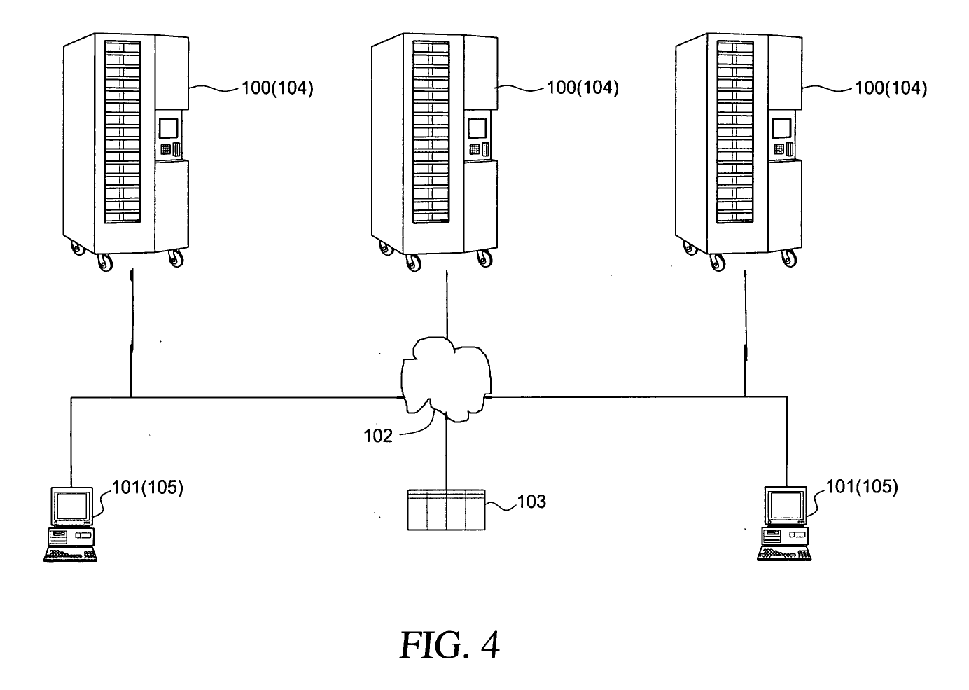

Exemplary embodiments of dispensing device 100 may be used in a stand-alone configuration, as illustrated in FIG. 3, or in a multiple device configuration, as illustrated in FIG. 4. In the stand-alone configuration, the device 100 is connected to a workstation 101 by any suitable connection known to those of ordinary skill in the art, for example, via a network 102, and to a database 103 which may be stored in the workstation or elsewhere on a network. In multiple device configurations, multiple devices 100 may be controlled by multiple workstations 101, with each workstation controlling one or more of the devices. In this exemplary embodiment, the devices and workstations are preferably connected to each other and to the database 103 by the network 102. The workstations 101 are not limited to a particular computing device, and may include notebook or other portable computing devices as well as desktop or other fixed computing devices.

In the exemplary embodiments illustrated in FIGS. 3 and 4, the dispensing device 100 is installed with local dispensing control software 104 that controls a user interface, the movement of the dispensing mechanism 5 (FIG. 2), and operation of the doors 11 (FIG. 1). The workstation 101 includes inventory (or administration) and control software 105 for one or more dispensing devices 100. Centralized data collection and reporting may be provided through the workstation, or through a server.

Exemplary embodiments of dispensing device 100 defer supervisory functions, including user validation, dispense decisions, item tracking, and so forth to the inventory and control software 105 provided on the workstation 101, with appropriate modification of the user interface provided through the display 4 of the dispensing device 100. The inventory and control software 105 uses the database 103 to track the contents of each compartment in the dispensing device 100, and may be fully interfaced to a main or central accounting system. For example, inventory and control software 105 can control the function of dispensing device 100, such as doors, etc., and actively manage the storage and dispensing of items from dispensing device 100 and process and retain related information, including, for example, records regarding the times employees received and returned Banks. Inventory and control software 105 is responsible for communications back and forth between dispensing device 100 and database 103, where applicable. The software 105 is operable to present and receive information graphically, such as through a graphical user interface (GUI), using multiple viewing windows to monitor and control various system components and features. Inventory and control software 105 may be implemented in any suitable high or low level language, such as C++, Java, or assembly language, and stored on any suitable computer readable media, such as read only memory (ROM) or magnetic disk.

Exemplary embodiments provide for inventory and control software 105 to be stored locally at dispensing device 100, which would therefore have its own built-in computer to store and execute software 105. Such as dispensing device would be operable as an independent, stand-alone device and interface with a network, if applicable. Alternatively, inventory and control software 105 can be maintained and operated remotely with dispensing device 105 serving as an access point, a so-called dumb terminal. Such remote installations include computer stations local to the dispensing device, that is, a local area network topology, and computer stations or workstations geographically remote to the dispensing device. Exemplary embodiments provide for remote dispensing capability and centralized monitoring. For example, dispensing devices can be maintained throughout the world, with some being dedicated to different items and applications. Any dispensing device 100 can then be monitored and controlled from a centralized location.

Exemplary embodiments provide for database 103 to be located at dispensing device 100, a local computer station, or any computer located over the network. Database 103 can be maintained partially or completely at any of the above locations. It can maintain its records dynamically in real time, or statically, being periodically refreshed (replicated) as needed.

Exemplary embodiments provide for reconciliation. In reconciliation, the employee identifies themselves and the Bank is returned, with the Banks being collected in the Blind Drop. At this point the Banks could be piece counted (counted up) or gathered and saved for a daily reconciliation. This the process of taking the items in the bags and accounting so that the cash management system can come up with a comma separated value (CSV) file of what was taken out and what was returned for exporting to POS system. This represents a full accounting of the bag from birth to death. Bags possess a unique identifier. For example, each Bank may have a serial number that is unique.

Exemplary embodiments provide for Proximity sensor associated with the doors. Each doo: has sensors that monitor the opening or closing of door. There could also be a proximity sensor to know if there is an item in the slot. Alternatively, each slot could have an RFID reader the check the unique bag.

Exemplary embodiments provide for an audit process to empty the machine if it is desired to account for everything that is in the machine. To perform this task, it is desirable to take everything out of the dispensing device to make sure everything matches in value. Bags may also need to be removed in the case of an upgrade or system repair, completely clean the machine out, or annual periodic audit by compliance people. Merely opens all doors in machine so bags can be taken out. When doors are closed, the machine resets the bags that were taken out to preassembled status so those bags can be reloaded later on, issued manually or even deleted from the system.

Exemplary embodiments provide for row and column control. Such control temporarily disables specific rows or columns from system logic. For example, such control disables a row when a machine door goes bad. If a door goes bad, it is desirable to prevent an entire row from being selected for access or loading; the software isolates the row from the system so the machine can continue operations; all the functions that call for that door are programmed out.

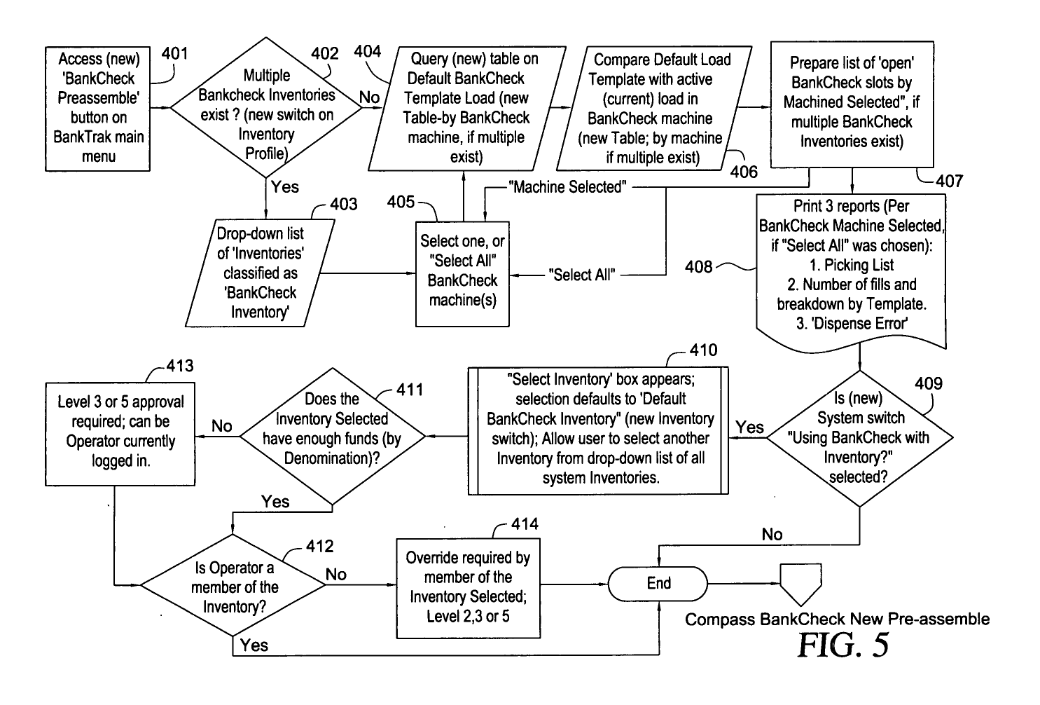

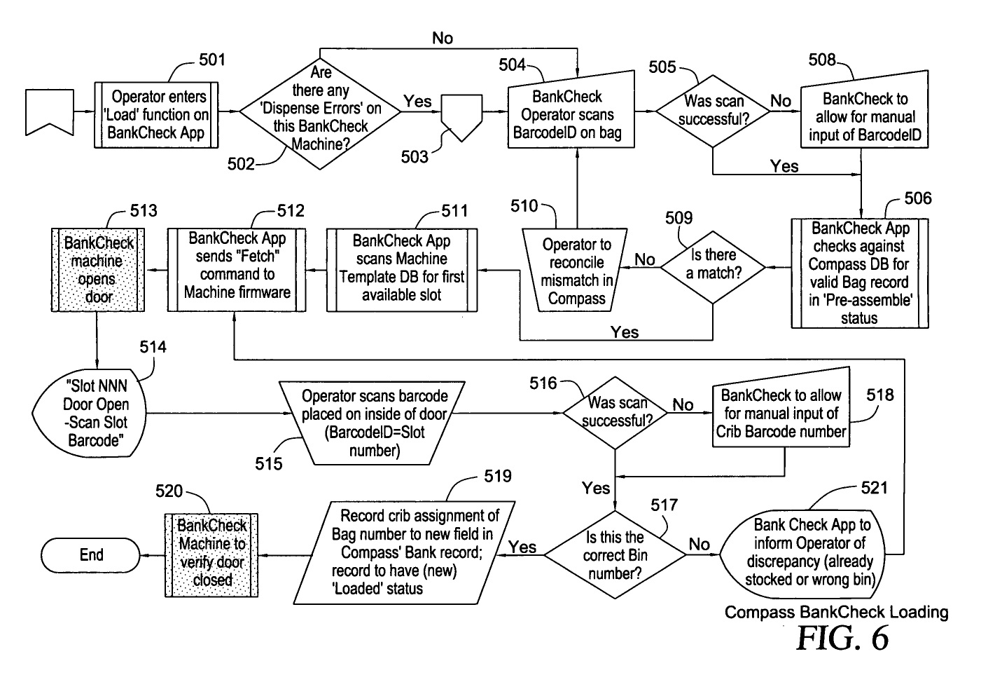

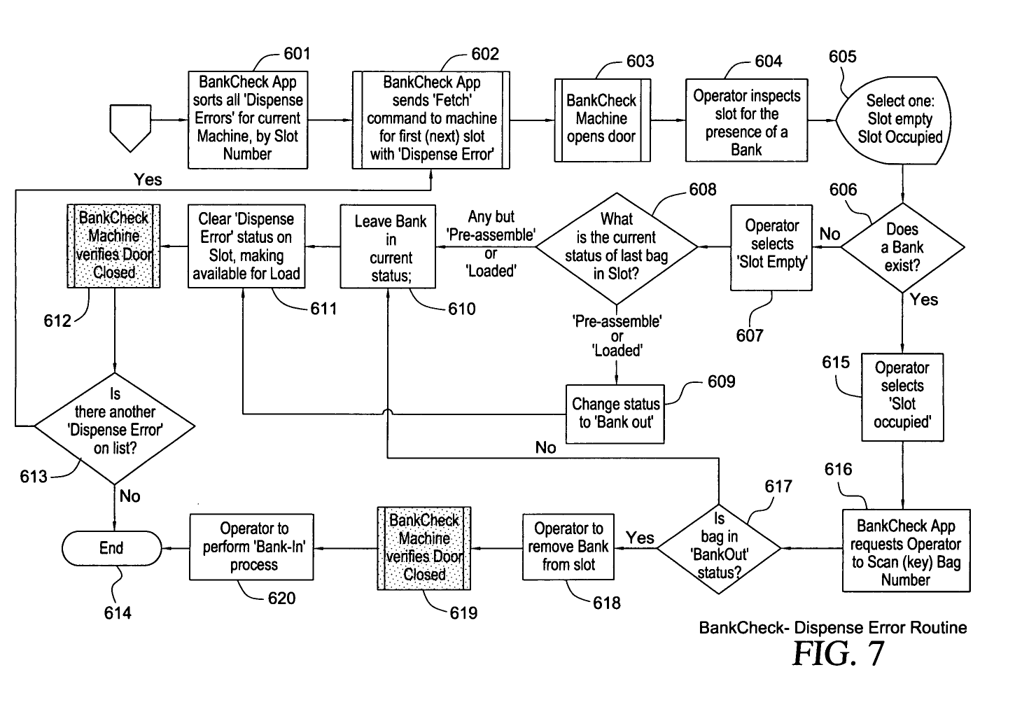

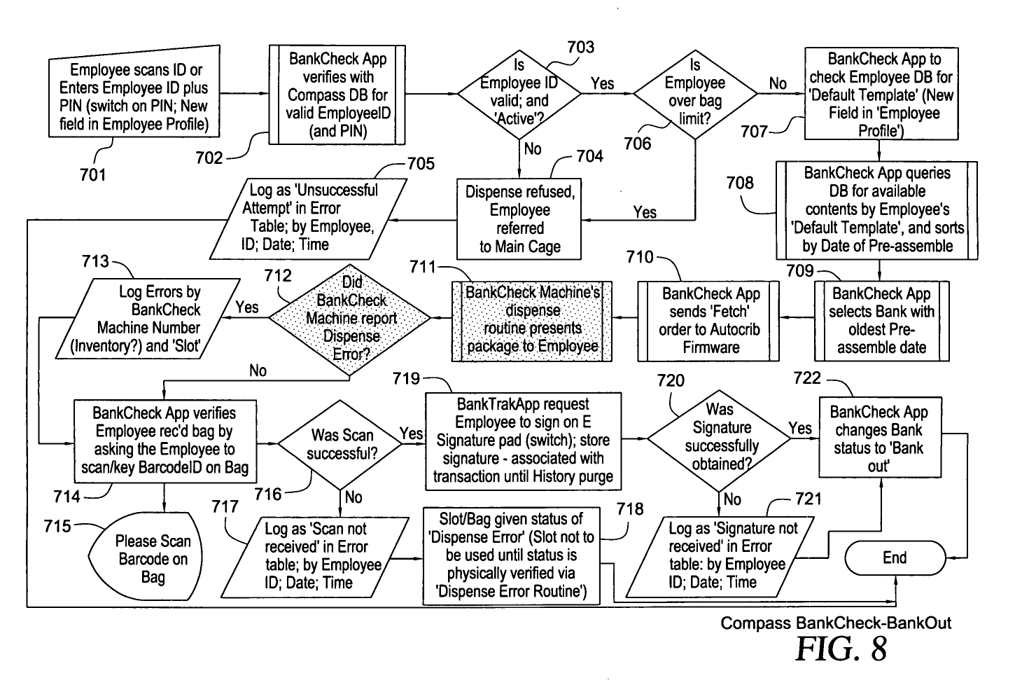

Operation of the central inventory and control software 105 in accordance with exemplary embodiments of the present invention is illustrated in FIGS. 5-8. FIG. 5 illustrates a routine for filling the dispensing devices. FIG. 6 illustrates a routine for controlling filling of a dispensing device, FIG. 7 illustrates a routine for checking compartments in case of a dispensing error and FIG. 8 illustrates a routine for dispensing items for the dispensing device.

The pre-assemble software routine calls up previously established inventories and assembles or relates them to templates that correspond to the physical layout of the compartments 7 in a dispensing device 100 to which a workstation 101 is connected, by filling-in the template according to the data in the inventory so that a user can view and track the contents of the dispensing device. Once a template is filled in, then additions and withdrawals from a compartment are carried out in accordance with the loading and removal routines of the exemplary embodiment of FIGS. 6 and 8, which adjust the filled-in template or inventory accordingly. The dispense error routine of the exemplary embodiment of FIG. 7 ensures that an inventory accurately reflects the contents of the dispensing device.

As illustrated in the exemplary embodiment of FIG. 5, the pre-assemble software routine is started upon selecting the pre-assemble button from a main menu in the central inventory and control software 105 (step 401), whereupon it checks the database for multiple inventories (step 402). If multiple inventories exist, the software drops down a list of inventories for selection by the operator (step 403). If only a single inventory exists, the software retrieves a template representing the compartment layout, which may for example be a graphical representation of the bin configuration, and a table with current inventory (step 404). If multiple inventories exist, the software first selects an inventory and a corresponding machine (step 405) and then proceeds to the step of retrieving a corresponding template and table. The retrieved table is then used to compare available slots listed in the default template with current inventory from the table (step 406) and a list of open slots is prepared (step 407). In case of multiple inventories, the software returns to step 405 to proceed to another machine, and repeats steps 404, 406, and 407 until a list of open slots has been obtained for each selected machine. The central inventory and control software 105 then prints reports. The reports may, for example, provide inventory lists (“picking list”), number of fills and breakdown by template, and dispense errors (step 408) for each selected machine.

After completing print-outs for selected dispensing devices, the software checks whether a switch has been selected that enables further operation of the dispensing devices (step 409). If the switch has been selected, the software proceeds to a subroutine that verifies operator authority and whether funds are sufficient to proceed. The first step in this subroutine is to display a “select inventory” box that enables the operator to select the inventories whose controls are to be enabled (step 410), and verifies whether enough funds are available for a dispensing operation to proceed (step 411). If sufficient funds are available, the software verifies the authority of the operator to enable the controls for the operator (step 412). If sufficient funds are not available, then the authorization level is raised (step 413). If the verification of authority indicates that the operator is authorized for the inventory selected, then the central inventory and control software is enabled and the routine ends. Otherwise, an override by an authorized user is required (step 414). After completion of the routine, the central inventory software proceeds to the exemplary embodiment of dispense error software routine of FIG. 6, which is described below.

The loading routine of the exemplary embodiment of FIG. 6 enables a user to fill open compartments in the dispensing device. As illustrated in FIG. 6, upon selection of the load routine (step 501), the software routine checks for dispense errors (step 502) and either proceeds to the dispense error routine of FIG. 7 (step 503) in case of errors, or waits for the operator to read an identifier, such as a barcode label, on a bank container or bag (step 504). The scan is then verified (step 505), followed by checking of the scanned ID against information in the database retrieved in the pre-assembly routine of FIG. 5 (step 506). If the scan cannot be verified, the software may optionally allow for manual input (step 508). If the bag ID does not correspond to an ID in the inventory, as determined at step 509, manual verification or supervisory intervention is required (step 510). Otherwise, the software scans the retrieved template for a first available slot (step 511) and sends a fetch command to the local control software 104 in the dispensing device (step 512), which causes the local control software in the dispensing device 100 to position a corresponding compartment 7 adjacent one of the doors 11, and to open the door so that the bank container or bag can be placed into the compartment (step 513). In an exemplary embodiment, a prompt is displayed by the central inventory and control software 105 (step 514) to cause the operator to scan/enter slot number or identifier (step 515) and the software verifies whether the scan was successful (step 516). If the scan was successful, the slot number is verified to determine whether it corresponds to the open slot listed in the inventory (step 517). If the scan was not successful, the software may permit manual input of the slot number or identifier (step 518). If the slot number is correct, then the compartment and bag number are associated in the database (step 519) and the local control software 104 verifies whether the door has been closed (step 520). If the slot number is incorrect, then the operator is informed and another compartment is made available (step 521).

An exemplary embodiment of the dispense error software routine shown in FIG. 7 begins by sorting recorded dispense errors by slot number for a particular one of the dispensing devices 100 (step 601) and sending an instruction to open the door corresponding to the first dispense error (step 602). After the local control software opens the door (step 603), the operator inspects the slot for the presence of a bank container or bag (step 604) and is asked to input whether the compartment or slot is empty or occupied (step 605).

If the slot is empty, as determined by the operator at step 606, the operator inputs that the slot is empty (step 607) and the software checks the current status of the last bank in the slot (step 608). If the dispense error routine was called by during the pre-assemble routine, then the status is changed in the inventory to “out” (step 609). Otherwise, the status is left unchanged (step 610). In either case, the dispense error status is then cleared, making the slot available for loading (step 611), the local control software verifies whether the door is closed (step 612), and the local control software proceeds to the next error, if any, or ends the routine (steps 613, 614).

If the slot is occupied, then the operator inputs slot occupied (step 615), the operator is prompted to scan the barcode of the container or bag that occupies the slot (step 616), and the number is checked against the inventory to determine is the bank is supposed to be there (step 617). If the bank is supposed to be there, then the routine jumps to step 610, and the status is left unchanged. If the bag is not supposed to be in the slot, then the operator removes the bag from the slot (step 618) and closes the door. After the local control software verifies that the door is closed (step 619), the operator performs a slot loading procedure (step 620).

An exemplary embodiment of the bank dispensing routine is illustrated in FIG. 8. Initially, an employee who wishes to obtain a bank from the dispensing device scans or enters his or her employee ID and a personal identification number or PIN (step 701). The central inventory and control software 105 then verifies the employee ID and PIN against corresponding entries in the database 103 (step 702) and determines whether the ID is valid and active (step 703). If not, dispensing is refused (step 704) and the refusal is logged (step 705). If the employee ID is active and valid, then the bag limit for the employee is checked (step 706) and dispensing is refused if the employee has already been dispensed his or her limit. If the employee is not over the limit, then the central inventory and control software retrieves a template of the dispensing device from the database (step 707), the template indicating compartments from which the employee is authorized to withdraw banks. This template is then matched against the current inventory (step 708) and the bank with the oldest pre-assemble date is selected (step 709). A door-opening instruction is sent to the dispensing device local control software 104 (step 710) and the local control software moves the corresponding compartment to adjacent an appropriate door and opens the door (step 711).

If a dispense error has previously recorded, as determined by the local control software (step 712), the central inventory and control software notes the error by dispensing device and slot identifiers or numbers (step 713). Whether or not an error has been logged, the employee is prompted to scan or enter an identifier on the bag (steps 714, 715) and verifies whether the scan was successful (step 716). If the scan was not successful, the failure is logged (step 717), and a dispense error is recorded, preventing the slot from being used until its status is physically verified using the dispense error routine, such as that illustrated by the exemplary embodiment of FIG. 7 (step 718). If the scan was successful, then the employee is requested to input identification data such as a signature (step 719) and signature input is verified (step 720). If the signature input cannot be verified, the failure is logged (step 721). If the signature input is verified, or after logging a signature failure, the central inventory and control software changes the status of the bank in the inventory to bank out and the routine is terminated (step 722).

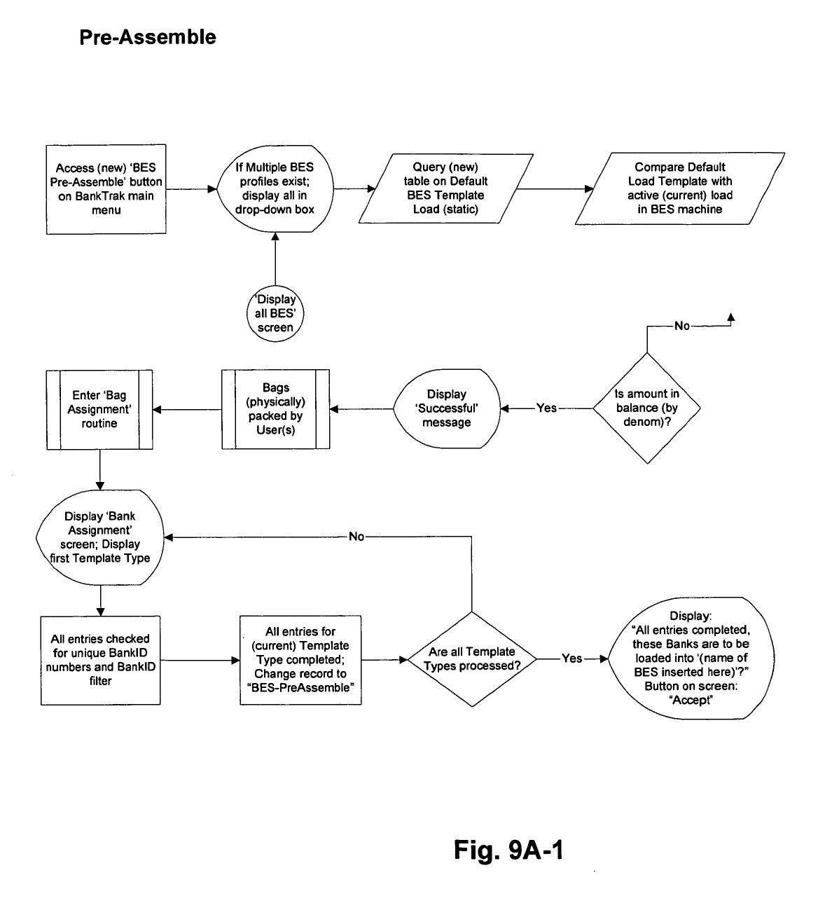

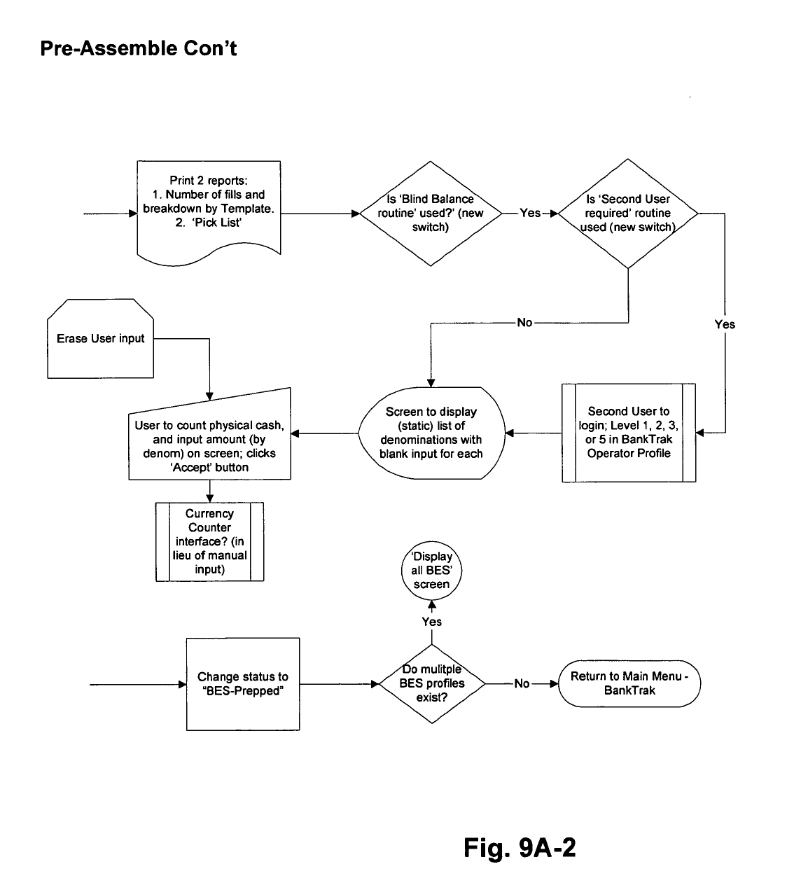

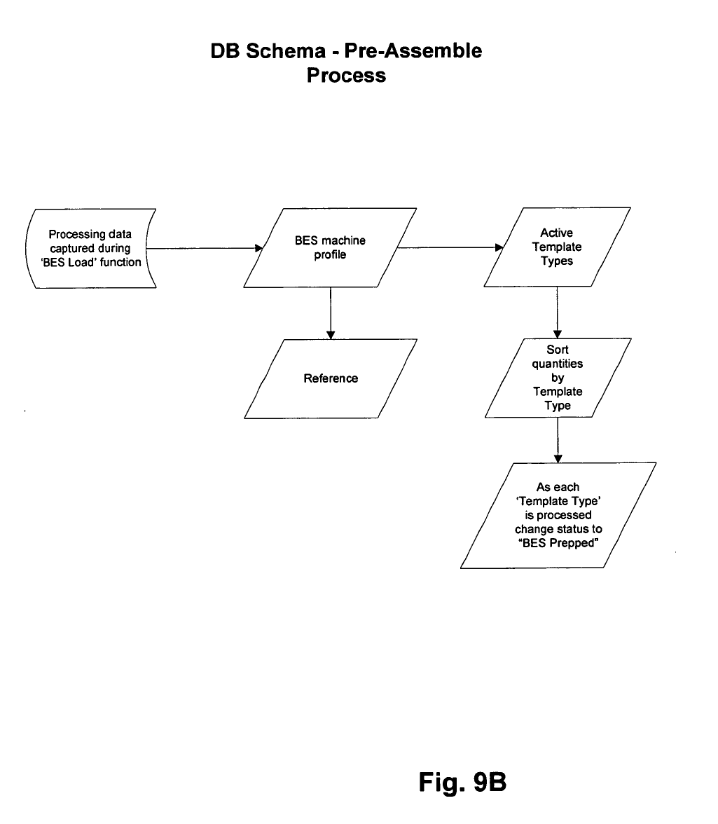

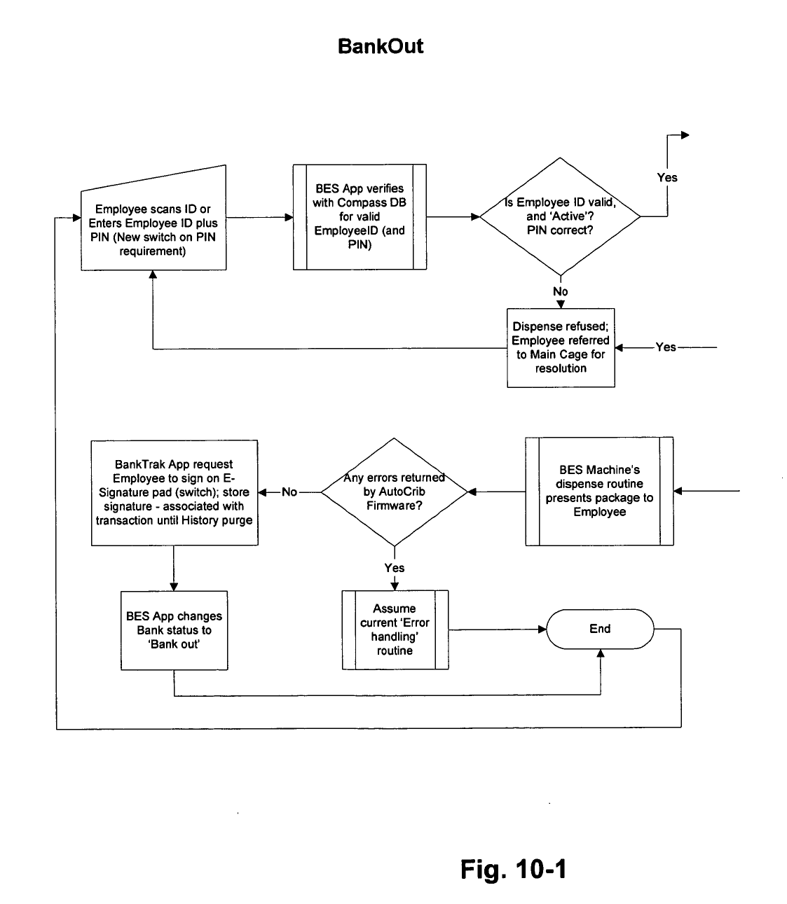

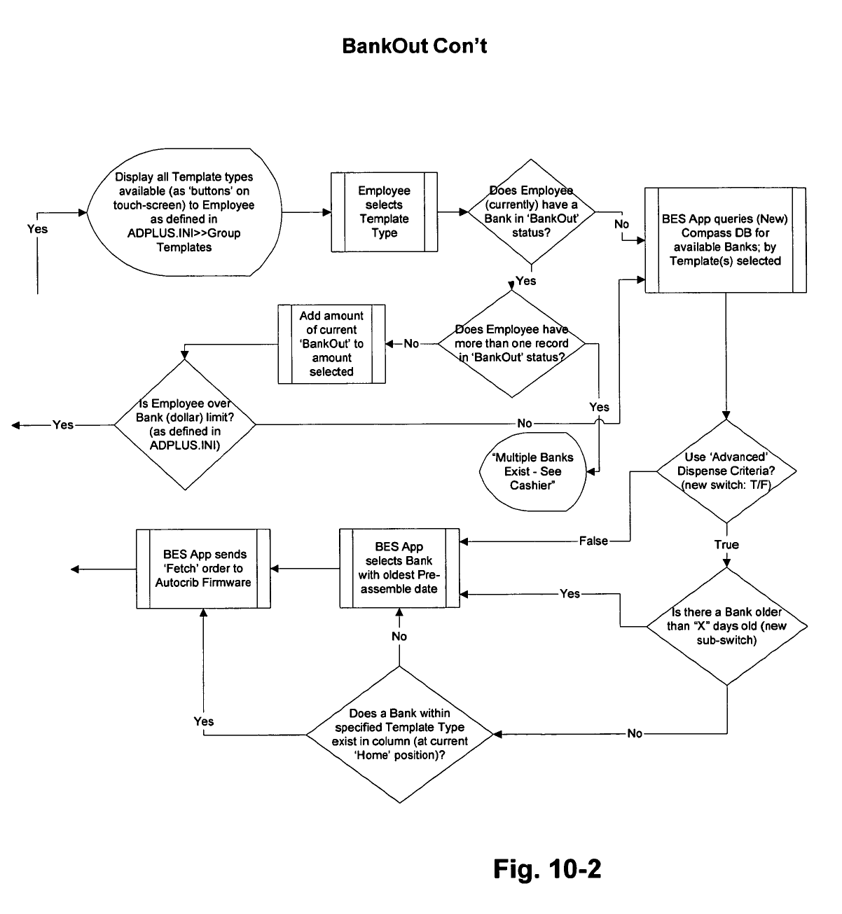

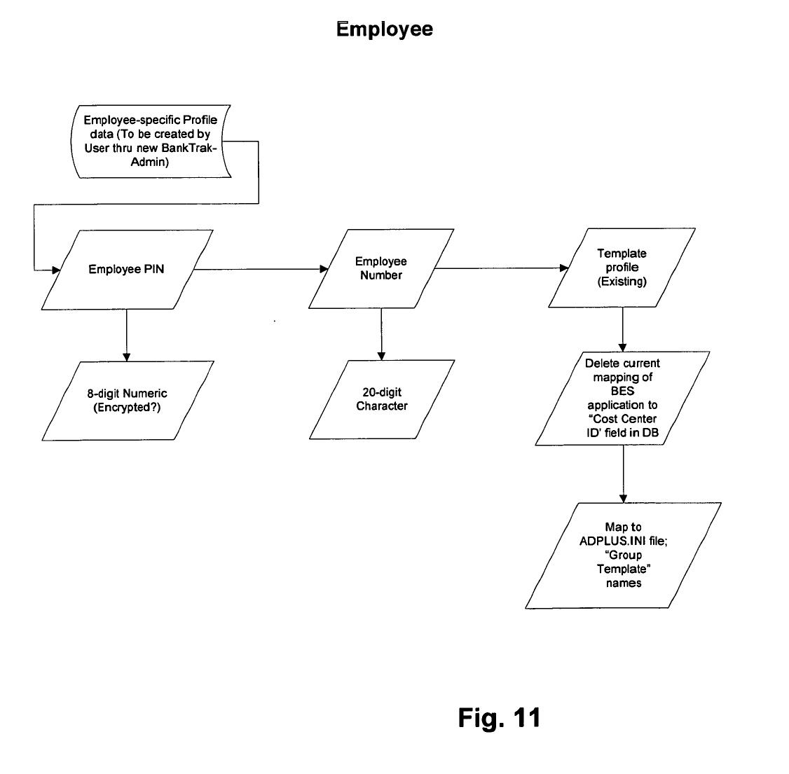

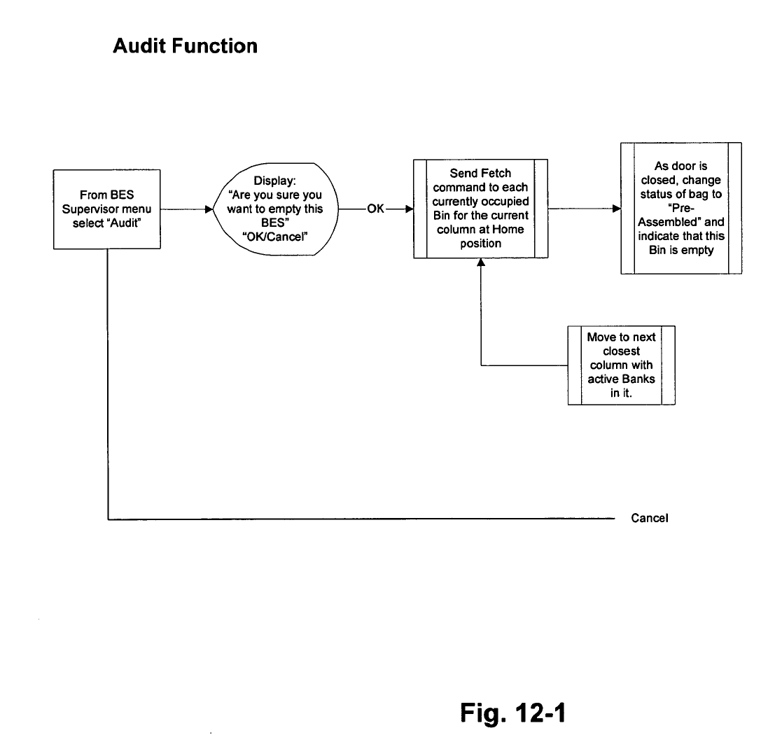

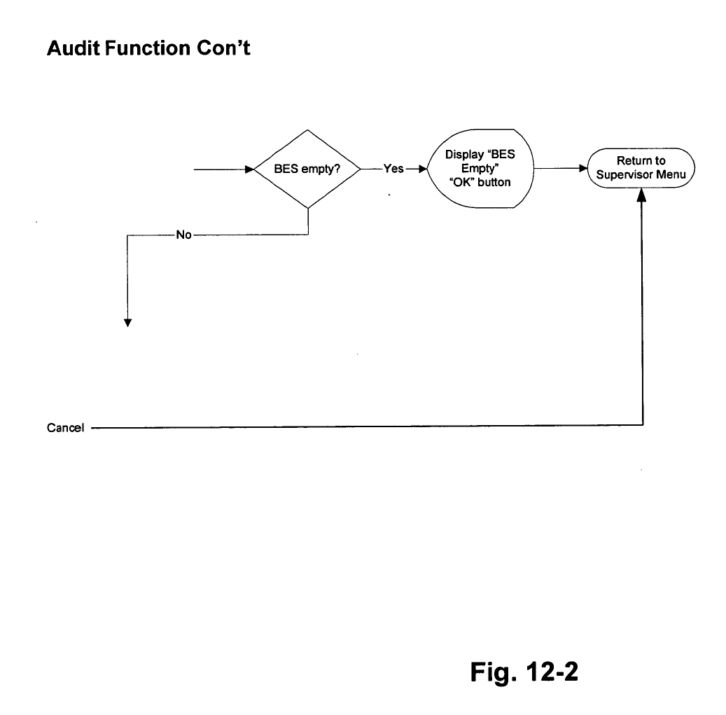

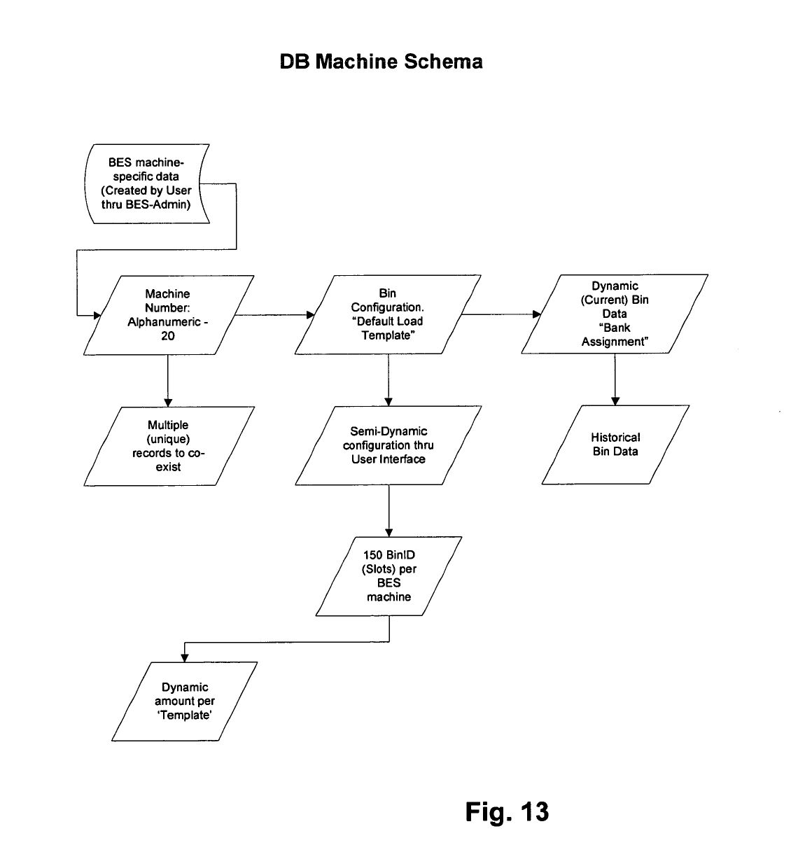

Operation of the central inventory and control software 105 in accordance with exemplary embodiments of the present invention is illustrated in FIGS. 9A-13.

While the present invention has been particularly shown and described with reference to certain exemplary embodiments thereof, it will be understood by those of ordinary skill in the art that various changes in form and detail may be made therein without departing from the spirit and scope of the present invention as defined by the appended claims. For example, one such exemplary embodiment includes an automated dispensing device for casino environments to facilitate back office operations by dispensing cash “Banks,” which are fixed amounts and denominational mixes of currency provided to casino employees for use in the performance of their jobs. The Bank dispensing devices or mechanisms of the system are stocked and replenished by casino tellers. The Banks are preferably implemented in the form of money bundles placed in reusable containers that fit within compartments of the dispensing device, although it is also possible to simply tie or clip the bundles together or store them in bags that fit within the dispensing device compartments, or any other suitable means of assembling and retaining the Bank as would be known to those of ordinary skill in the art.

What is claimed is:

1. A system for dispensing items of value, comprising:
a dispensing device including a plurality of compartments for holding said items of value, a plurality of doors through which items of value are placed into or removed from a compartment, a moving mechanism for moving said compartments to positions adjacent the doors, and local control software for controlling said moving mechanism and for opening said doors to provide access to respective compartments positioned adjacent said doors; and
a workstation connected to the dispensing device, said workstation including central inventory and control software for tracking contents of said compartments and for providing instructions to cause said local control software to open said doors.

2. A system as claimed in claim 1, wherein said central inventory and control software provides all supervisory functions including user validation, dispense decisions, and item tracking.

3. A system as claimed in claim 1, wherein said workstation is connected to said dispensing device through a network.

4. A system as claimed in claim 3, wherein said workstation is further connected through said router to a database containing inventories.

5. A system as claimed in claim 1, wherein said central inventory and control software is arranged to retrieve inventories from a database and merge the inventories with templates representing layouts of dispensing devices to which the workstation is connected.

6. A system as claimed in claim 5, wherein said printing of inventories includes printing of inventory lists, number of fills and breakdown by template, and dispense errors for selected dispensing devices.

7. A system as claimed in claim 5, wherein before operation of a dispensing device is enabled, the central inventory and control software verifies whether funds are sufficient to proceed and verifies identity and authority of an operator.

8. A system as claimed in claim 1, wherein upon loading or removing an item from a compartment, the central inventory and control software checks an identifier corresponding to the item being loaded or removed, and updates a corresponding inventory.

9. A system as claimed in claim 8, wherein said item being loaded or removed is associated with an identifier.

10. A system as claimed in claim 8, wherein an identifier is associated with each door, and entered whenever a door is accessed to verify a number of the door through which an item is loaded or removed.

11. A system as claimed in claim 1, wherein the central inventory and control software verifies an employee's identification number and a PIN before permitting an employee to remove an item from a compartment by instructing the local control software to open a door.

12. A system as claimed in claim 11, wherein the central inventory and control software checks whether the employee has exceeded a daily limit for authoring removal of an item.

13. A method for dispensing items of value, comprising:
providing a dispensing device including a plurality of compartments for holding said items of value, a plurality of doors through which items of value are placed into or removed from a compartment, a moving mechanism for moving said compartments to positions adjacent the doors, and local control software for controlling said moving mechanism and for opening said doors to provide access to respective compartments positioned adjacent said doors; and
using a workstation connected to the dispensing device to track contents of said compartments and for providing instructions to cause said local control software to open said doors.

14. A method as claimed in claim 13, wherein the step of using the workstation comprises the step of using the workstation to provide all supervisory functions including user validation, dispense decisions, and item tracking.

15. A method as claimed in claim 13, wherein said step of using the workstation to control said dispensing device comprises the steps of retrieving inventories from a database and merging the inventories with templates representing layouts of dispensing devices to which the workstation is connected to enable display and printing of said inventories.

16. A method as claimed in claim 15, wherein said step of printing the inventories includes the step of printing inventory lists, number of fills and breakdown by template, and dispense errors for selected dispensing devices.

17. A method as claimed in claim 15, wherein said step of using the workstation to control said dispensing device further comprises the steps of, before enabling operation of a dispensing device, verifying whether funds are sufficient to proceed and verifying identity and authority of an operator.

18. A method as claimed in claim 13, wherein said step of using the workstation to control said dispensing device further comprises the steps of, upon loading or removing an item from a compartment, checking an identifier corresponding to the item being loaded or removed, and updating a corresponding said inventory.

19. A method as claimed in claim 18, wherein said item being loaded or removed is associated with an identifier.

20. A method as claimed in claim 18, wherein an identifier is associated with each door, and entered whenever a door is accessed to verify a number of the door through which an item is loaded or removed.

21. A method as claimed in claim 13, wherein said step of using the workstation to control said dispensing device further comprises the step of verifying an employee's identification number and a PIN before permitting an employee to remove an item from a compartment by instructing the local control software to open a door.

22. A method as claimed in claim 21, wherein said step of using the workstation to control said dispensing device further comprises the steps of checking whether an employee has exceeded a daily limit for authoring removal of an item.
